(19) United States
(12) Patent Application Publication
(10) Pub. No.: US 2007/0221832 A1
(43) Pub. Date: Sep. 27, 2007

(54) Portable electronic device with electronic lock

(76) Inventors: Toon-Jeow Foo, Taipei (TW); Steel Su, Taipei (TW); Shen-Feng Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/384,665

(22) Filed: Mar. 21, 2006

(51) Int. Cl. G01D 5/34

(52) U.S. Cl. 250/231.14

(57) ABSTRACT

The present invention provides a portable electronic device with an electronic lock, comprising a rotary encoder and a micro-controller. The rotary encoder is rotatable to generate encoding signals. The micro-controller is connected to the rotary encoder and receives the encoding signals. The micro-controller then uses the encoding signals to determine whether the electronic device can be used.

### FIELD OF THE INVENTION

The present invention relates to an electronic device, and more particularly, to a portable electronic device with an electronic lock.

### BACKGROUND OF THE INVENTION

The conventional portable electronic devices, such as a portable disk drive, a MP3 player, have already been widely used. These conventional portable electronic devices have one common characteristic, that is, after these conventional portable electronic devices are supplied with power, they should be immediately used. This kind of “power on and activate” design method for the conventional portable electronic devices cannot prevent others from arbitrarily using the conventional portable electronic devices, although it provides a very convenient method of use. For example, anyone who acquires the conventional portable disk drive can read the data stored therein, consequently, the confidential documents can be exposed to unrelated people.

In order to overcome the disadvantage of the conventional portable electronic device, the inventor of the present invention provides an improved an electronic device with an electronic lock to overcome the issue mentioned above.

### SUMMARY OF THE INVENTION

Accordingly, an object of the present invention is to provide an electronic device with an electronic locking function, so as to prevent others from using it.

In order to accomplish the above-mentioned aspect, the present invention provides an electronic device with an electronic lock, comprising: a rotary encoder and a micro-controller. The rotary encoder is rotatable to generate encoding signals. The micro-controller is connected to the rotary encoder and receives the encoding signals generated by the rotary encoder. The micro-controller uses the encoding signals to determine whether the electronic device can be used.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE INVENTION

The various objects and advantages of the present invention will be more readily understood from the following detailed description when read in conjunction with the appended drawing, in which:

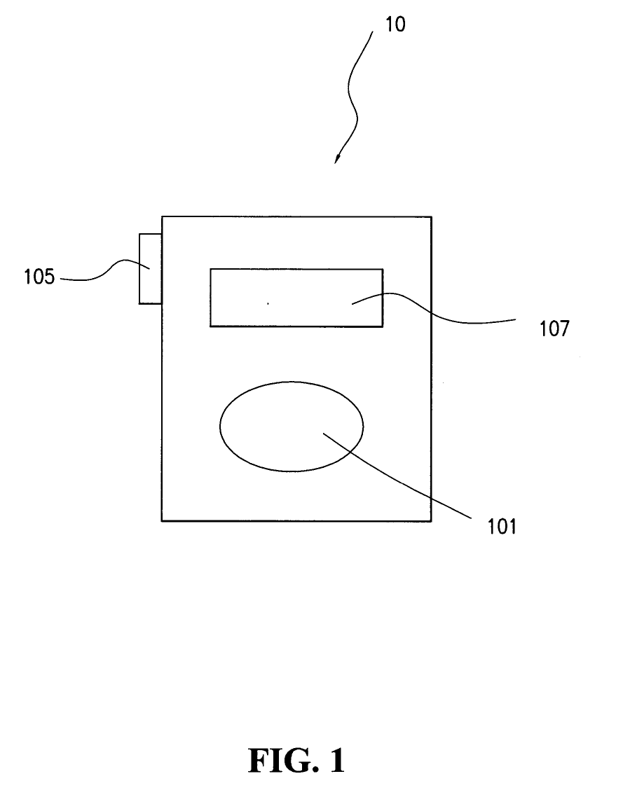

FIG. 1 shows a schematic view of the electronic device with an electronic lock in accordance with the present invention;

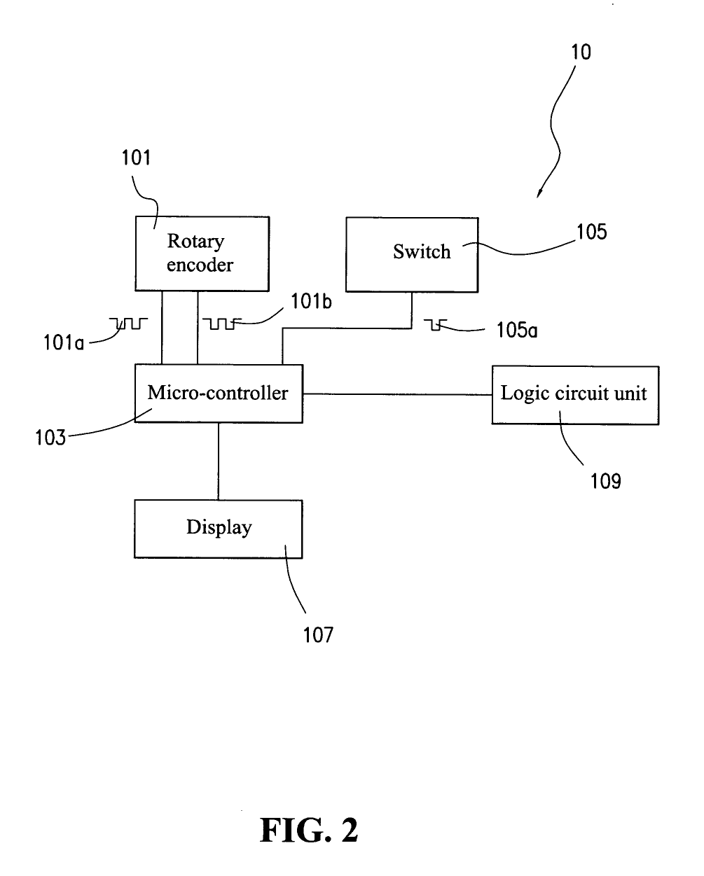

FIG. 2 shows a circuit block diagram of the electronic device with an electronic lock in accordance with the present invention;

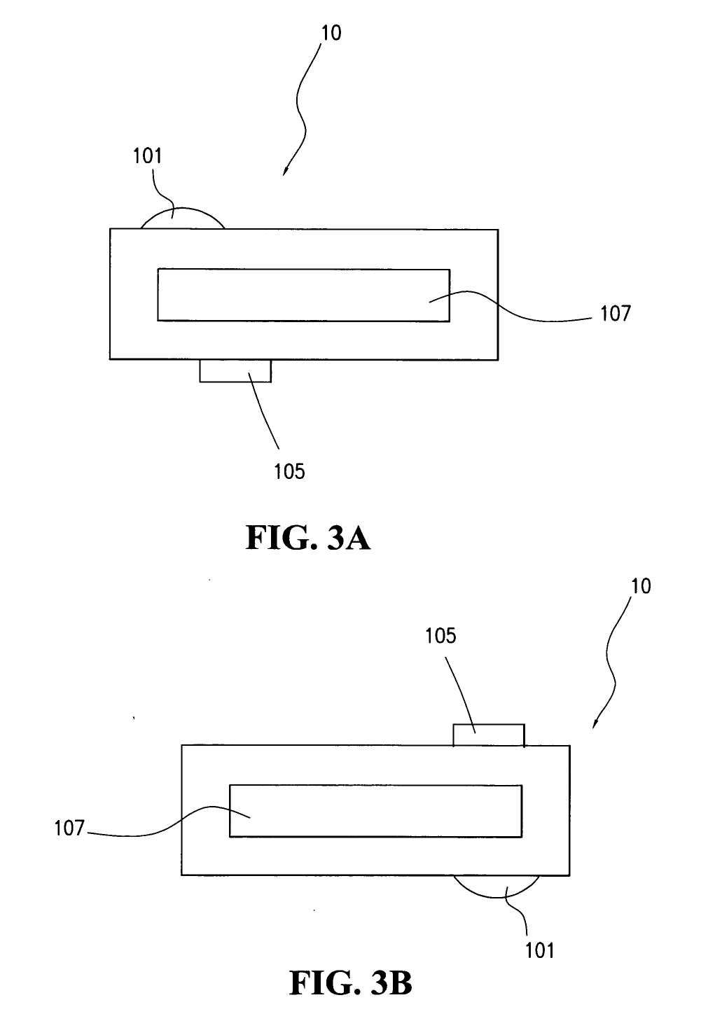

FIGS. 3A to 3C respectively show a schematic view of the electronic device with an electronic lock in accordance with the embodiment of the present invention; and

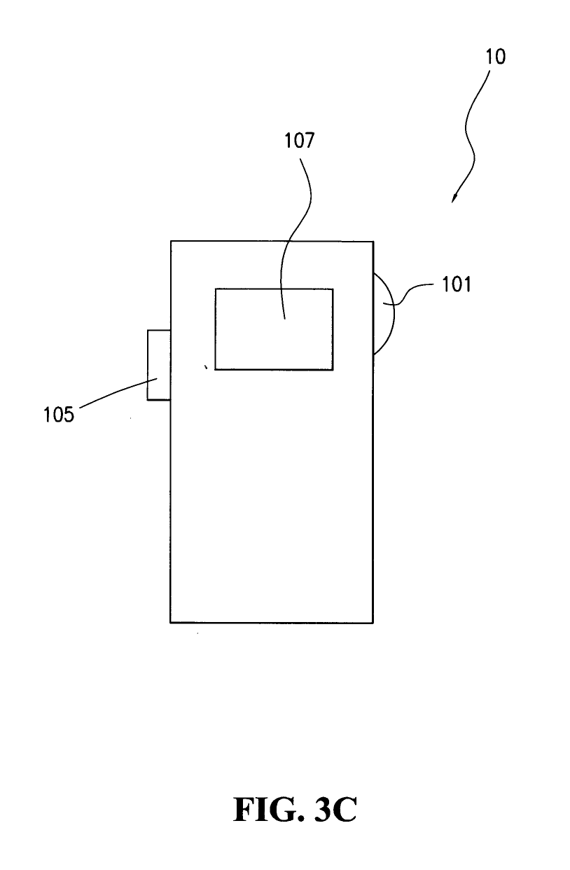

FIGS. 4A and 4B respectively shows the waves of encoding signals generated by the rotary encoder that be rotated in the first and second rotating direction.

### DETAILED DESCRIPTION OF THE INVENTION

FIG. 1 shows a schematic view of the electronic device with an electronic lock in accordance with the present invention, FIG. 2 shows a circuit block diagram of the electronic device with an electronic lock in accordance with the present invention, and FIGS. 3A to 3C respectively shows a schematic view of other variations of the electronic device with an electronic lock in accordance with the present invention. The electronic device 10 with the electronic lock of the present invention provides a safety mechanism similar to the safety lock for the safety box. When a user is ready to use the electronic device 10, he must rotatably operate the rotary encoder 101 at least once, just as operating the safety lock on the safety box. The user inputs a password by operating the rotary encoder 101. After the password is verified, the electronic device 10 is allowed to be used normally.

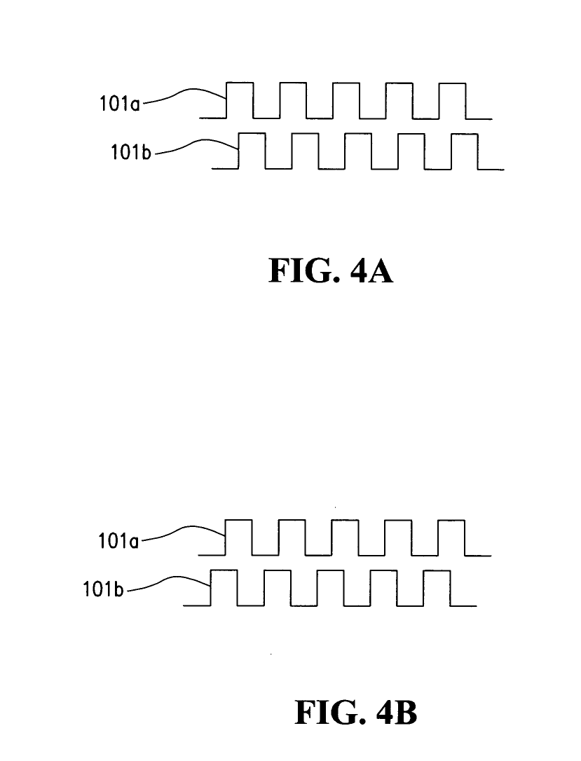

The functionality of rotary encoder 101 is to provide password input means identical to the safety lock for the safety box. The rotary encoder 101 generates encoding signals 101a, 101b through a rotary operation. Please refer to FIGS. 4A and 4B. The rotary encoder 101 can be rotatably operated in a first rotating direction such as a clockwise rotary operation, and in a second rotating direction, such as a counterclockwise rotary operation respectively, to generate different encoding signals 101a, 101b in FIG. 4A and 101a, 101b in FIG. 4B respectively. The micro-controller 103 is connected to the rotary encoder 101, and receives at least one encoding signal 101a, 101b generated by the rotary encoder 101. The micro-controller 103 determines whether the electronic device 10 is allowed to be used based the encoding signals 101a, 101b. That is, the encoding signals 101a, 101b represents a password, for example, the password consisting of encoding signals 101a, 101b by rotating 5 turns of counterclockwise, and encoding signals 101a, 101b by rotating 3 turns clockwise.

The switch 105 is connected to the micro-controller 103 and is used for generating at least one switch signal 105a. The micro-controller 103 determines the processing means for the encoding signals 101a, 101b based on the total turn number of the switch 105 being continuously pressed. For example, the user can first press the switch 105 once, and then rotatably operate the rotary encoder 101 to input the password, and then continuously press the switch 105 twice to indicate the completion of password input. Alternatively, the user only press the switch 105 once, and then stop performing any operation on the electronic device 10 for a given period, such as in 2 seconds. After the given period has past, the micro-controller 103 clears the password previously inputted. The switch 105 of the present invention can be implemented as a tact switch.

The display 107 of the electronic device 10 in accordance with the present invention is for displaying the rotary operation status of the rotary encoder 103. For example, the user can rotate 5 numbers counterclockwise to rotatably operate the rotary encoder 103, and the displayer 107 will show the corresponding message of 5 numbers counterclockwise. The display 107 of the present invention can be implemented as a small LED.

An embodiment of the electronic device 10 in accordance with the present invention includes a player, a data storage device, a setup box, a video player, etc. Moreover, an embodiment of the electronic device 10 in accordance with the present invention can be a portable electronic device, such as a portable disk drive, a palm-sized MP3 player, a portable digital TV player, a portable video player, a portable data storage device, etc. Based on the different embodiments of the electronic device 10, a corresponding logical circuit unit 109 is implemented as the corresponding circuit.

Because the present invention incorporates the function of an electronic lock, the electronic device 10 is improved with security effect; meanwhile, it can prevent others from using it, providing advantages beyond that of the conventional electronic device.

While the present invention has been described by way of examples and in terms of a preferred embodiment, it is to be understood that the present invention is not limited thereto. It should be understood that the detailed description and specific examples, while indicating preferred embodiments of the present invention, are given by way of illustration only, since various changes and modifications within the spirit and scope of the present invention will become apparent to those skilled in the art from this detailed description. Therefore the scope of the appended claims should be accorded the broadest interpretation so as to encompass all such changes and modifications.

What is claimed is:

1. A portable electronic device with an electronic lock, comprising:
a rotary encoder being rotatable to generate at least one encoding signal; and
a micro-controller connected to said rotary encoder, and receiving said encoding signals, wherein said micro-controller uses said encoding signals to determine whether said portable electronic device is to be used.

2. The portable electronic device of claim 1, wherein said rotary encoder is capable of being rotatable in a first rotating direction and a second rotating direction respectively to generate different said encoding signals respectively.

3. The portable electronic device of claim 1, further comprising: a switch connected to said micro-controller, and being used to generate at least one switch signal, wherein said switch signals are used to instruct said micro-controller on how to process said encoding signals generated by said rotary encoder.

4. The portable electronic device of claim 3, wherein said switch is a tact switch.

5. The portable electronic device of claim 3, wherein said micro-controller receives said switch signals and determines a processing means for said encoding signals based on a total number of said switch signals generated continuously.

6. The portable electronic device of claim 1, further comprising: a display for displaying a rotary operation status of said rotary encoder.

7. The portable electronic device of claim 6, wherein said display is a small LED.

8. The portable electronic device of claim 1, wherein said portable electronic device is a portable player.

9. The portable electronic device of claim 1, wherein said portable electronic device is a portable data storage device.

10. The portable electronic device of claim 1, wherein said portable electronic device is a portable video player.

11. An electronic device with an electronic lock, comprising:
a rotary encoder being rotatable to generate at least one encoding signal; and
a micro-controller connected to said rotary encoder, and receiving said encoding signals, wherein said micro-controller uses said encoding signals to determine whether said electronic device is to be used.

12. The electronic device of claim 11, wherein said rotary encoder is capable of being rotatable in a first rotating direction and a second rotating direction respectively so as to generate different said encoding signals respectively.

13. The electronic device of claim 11, further comprising: a switch connected to said micro-controller, and being used for generating at least one switch signal, wherein said switch signals are used for instructing said micro-controller on how to process said encoding signals generated by said rotary encoder.

14. The electronic device of claim 13, wherein said switch is a tact switch.

15. The electronic device of claim 13, wherein said micro-controller receives said switch signals, and determines a processing means for said encoding signals based on a total number of said switch signals generated continuously.

16. The electronic device of claim 11, further comprising: a display for displaying a rotary operation status of said rotary encoder.

17. The electronic device of claim 16, wherein said display is a small LED.

18. The electronic device of claim 11, wherein said electronic device is a player.

19. The electronic device of claim 11, wherein said electronic device is a data storage device.

20. The electronic device of claim 11, wherein said electronic device is a video player.
